(19) United States
(12) Patent Application Publication
(10) Pub. No.: US 2013/0203897 A1
(43) Pub. Date: Aug. 8, 2013

(54) ELECTRICAL INSULATION SYSTEM

(71) Applicants: Xavier KORNMANN, Lauchringen (DE); Lars E. Schmidt, Oskarshamn (SE); Andrej Krivda, Wettingen (CH); Felix Greuter, Baden-Rutihof (CH); Martin Carlen, Niederrohrdorf (CH)

(72) Inventors: Xavier KORNMANN, Lauchringen (DE); Lars E. Schmidt, Oskarshamn (SE); Andrej Krivda, Wettingen (CH); Felix Greuter, Baden-Rutihof (CH); Martin Carlen, Niederrohrdorf (CH)

(73) Assignee: ABB RESEARCH LTD, Zurich (CH)

(21) Appl. No.: 13/566,580

(22) Filed: Aug. 3, 2012

Related U.S. Application Data
(63) Continuation of application No. PCT/EP2010/051298, filed on Feb. 3, 2010.

(51) Int. Cl. C08K 3/22; C08K 3/36

(52) U.S. Cl. CPC C08K 3/22; C08K 3/36
USPC 523/459; 428/402; 523/466; 523/457

(57) ABSTRACT

Electrical insulation system with improved electrical breakdown strength, including a hardened polymer component having incorporated therein a filler material and a nano-scale sized filler material. The hardened polymer component is selected from epoxy resin compositions, polyesters, polyamides, polybutylene terephthalate, polyurethanes and polydicyclo-pentadiene. The filler material has an average particle size within the range of 1 μm-500 μm, and is present in a quantity within the range of 40%-65% by weight, calculated to the total weight of the insulation system. The nano-scale sized filler material is a pretreated nano-scale sized filler material, having been produced by a sol-gel process. The nano-scale sized filler material is present within the electrical insulation system in an amount of about 1%-20% by weight, calculated to the weight of the filler material present in the electrical insulation system.

### RELATED APPLICATION

This application claims priority as a continuation application under 35 U.S.C. §120 to PCT/EP2010/051298 filed as an International Application on Feb. 3, 2010 designating the U.S., the entire content of which is hereby incorporated by reference in its entirety.

### FIELD

The present disclosure relates to an electrical insulation system with improved electrical breakdown strength.

### BACKGROUND INFORMATION

Electrical insulations, for example, in embedded poles, instrument and distribution transformers or sensors, can include an epoxy resin cured with an acid anhydride in the presence of an accelerator. The starting components can be mixed together with a filler material, for example, with silica flower, for example, in the range of 60 to 65% by weight of filler material, calculated to the total weight of the electrical insulator composition. The mixture can then be cured. Alternative polymers can also be used such as polyesters, polyamides, polybutylene terephthalate, polyurethanes or poly-dicyclopentadiene. A large amount of filler can decrease the overall price of the insulation. However, it can also increase the stiffness, the fracture toughness, the thermal conductivity of the insulator and can decrease its thermal expansion coefficient.

Cracking in epoxy based insulation can be a recurrent problem in such electrical insulators. Increasing toughness can be desirable to improve this situation. In electrical machine insulations, simultaneously increasing the glass transition temperature and the toughness of the resin can lead to an increase of the thermal class of the insulation, which means that the electrical machines can be run at higher current ratings.

An exemplary desirable property for the reliability of an electrical insulation material is that it has a high electrical breakdown strength and, therewith, good insulating properties at high electrical field strengths. International Publication No. WO 2006/008422 proposes the production of an electrical insulator for high voltage use comprising a mineral filler material wherein the mineral filler material is a combination of a filler material with an average particle size distribution within the micron-scale together with a selected filler material with an average particle size distribution within the nano-scale, for example, less than 1 μm. However, such a combination, for example, for industrial potting applications, for example, with epoxy resins, can have the disadvantage that it increases the viscosity of the curable epoxy resin composition and therewith reduces its processability. It can be difficult to incorporate the nano sized filler material homogenously within the curable electrical insulation composition.

### SUMMARY

According to an exemplary aspect, disclosed is an electrical insulation system with improved electrical breakdown strength, said electrical insulation system comprising a hardened polymer component (a) having incorporated therein a first filler material (b) and a second nano-scale sized filler material (c), wherein said hardened polymer component contains an epoxy resin composition, polyester, polyamide, polybutylene terephthalate, polyurethane, polydicyclopentadiene or a combination thereof, wherein said first filler material (b) contains a silica, quartz, talc, silicate, aluminum oxide, aluminum trihydrate (ATH), titanium oxide, dolomite, metal nitride, metal carbide or a combination thereof, wherein said second nano-scale sized filler material contains a silica, zinc oxide, alumina, aluminum trihydrate (ATH), layered silicate, titanium dioxide, metal nitride, metal carbide or a combination thereof, wherein said second nano-scale sized filler material is a pretreated nano-scale material, having been produced by a sol-gel process, wherein said second nano-scale sized filler material is present in the electrical insulation system in an amount of about 1%-20% by weight, wherein said second nano-scale sized filler material has an average particle size in a range of 2 nm-300 nm.

According to an exemplary aspect, disclosed is a hardenable electrical insulation composition for producing a hardened electrical insulation system, said hardenable electrical insulation composition comprising a hardenable polymer component having incorporated therein a first filler material (b) and a second nano-scale sized filler material, wherein said hardenable polymer component contains a monomeric or oligomeric starting material that is a hardenable epoxy resin composition, hardenable polyamide, polybutylene terephthalate, polyurethane, polydicyclopentadiene or a combination thereof, wherein said first filler material (b) has an average particle size distribution in a range of 1 μm-500 μm, wherein said first filler material (b) is present in a quantity in a range of 40%-65% by weight, calculated to the total weight of the hardenable electrical insulation composition, wherein said second nano-scale sized filler material is produced by a sol-gel process, wherein said second nano-scale sized filler material is present in the hardenable electrical insulation composition in an amount of about 1%-20% by weight, calculated to the weight of the first filler material (b) present in the hardenable electrical insulation composition.

According to an exemplary aspect, disclosed is a method of producing the hardenable electrical insulation composition, the method comprising mixing the components of said hardenable electrical insulation composition, optionally under vacuum, in any sequence.

According to an exemplary aspect, disclosed is a masterbatch for producing a hardenable electrical insulation composition, said masterbatch comprising: a hardenable polymer component, and a nano-scale sized filler material as the only filler material, wherein said hardenable polymer component contains a monomeric or oligomeric starting material that is a hardenable epoxy resin composition, hardenable polyamide, polybutylene terephthalate, polyurethane, polydicyclopentadiene or a combination thereof, wherein said nano-scale sized filler material contains a silica, zinc oxide, alumina, aluminum trihydrate (ATH), layered silicate, titanium dioxide, metal nitride, metal carbide or a combination thereof, wherein said nano-scale sized filler material is a pretreated nano-scale material, having been produced by a sol-gel process, wherein said nano-scale sized filler material has an average particle size in a range of 2 nm-300 nm.

According to an exemplary aspect, disclosed is a mixture for producing a hardenable electrical insulation composition, said mixture comprising: a first filler material (b), and a second nano-scale sized filler material, wherein said first filler material (b) contains a silica, quartz, talc, silicate, aluminum oxide, aluminum trihydrate (ATH), titanium oxide, dolomite, metal nitride, metal carbide or a combination thereof, wherein said second nano-scale sized filler material contains a silica, zinc oxide, alumina, aluminum trihydrate (ATH), layered silicate, titanium dioxide, metal nitride, metal carbide or a combination thereof, wherein said second nano-scale sized filler material is a pretreated nano-scale material, having been produced by a sol-gel process, wherein said second nano-scale sized filler material has an average particle size in a range of 2 nm-300 nm, and wherein said second nano-scale sized filler material is present in an amount of 1%-20% by weight, calculated to the weight of the first filler material (b).

According to an exemplary aspect, disclosed is a pretreated nano-scale sized filler material for producing a hardenable electrical insulation composition, the pretreated nano-scale sized filler material comprising a silica, zinc oxide, alumina, aluminum trihydrate (ATH), layered silicate, titanium dioxide, metal nitride, metal carbide or a combination thereof, wherein said nano-scale sized filler material is a pretreated nano-scale material, having been produced by a sol-gel process, wherein said nano-scale sized filler material has an average particle size in a range of 2 nm-300 nm, wherein said pretreated nano-scale sized filler material carries surface reactive glycidyl groups.

According to an exemplary aspect, disclosed is an electrical insulation system with improved electrical breakdown strength, said electrical insulation system comprising a hardened polymer component having incorporated therein a nano-scale sized filler material, wherein the hardened polymer component is substantially free of a filler material (b) which has an average particle size distribution in a range of 1 μm-500 μm, and which contains a silica, quartz, talc, silicate, aluminum oxide, aluminum trihydrate (ATH), titanium oxide, dolomite, metal nitride, metal carbide or a combination thereof, wherein said hardened polymer component contains an epoxy resin composition, polyester, polyamide, polybutylene terephthalate, polyurethane, polydicyclopentadiene or a combination thereof, wherein said nano-scale sized filler material contains a silica, zinc oxide, alumina, aluminum trihydrate (ATH), layered silicate, titanium dioxide, metal nitride, metal carbide or a combination thereof, wherein said nano-scale sized filler material is a pretreated nano-scale material, having been produced by a sol-gel process, wherein said nano-scale sized filler material has an average particle size in a range of 2 nm-300 nm, wherein said nano-scale sized filler material is present within the electrical insulation system in an amount of about 1%-20%, calculated to the total weight of the electrical insulation system.

According to an exemplary aspect, disclosed is a hardenable electrical insulation composition for producing an electrical insulation system, wherein said hardenable electrical insulation composition comprises a hardenable polymer component having incorporated therein a nano-scale sized filler material, wherein the hardened polymer component is substantially free of a filler material (b) which has an average particle size distribution in a range of 1-500 μm, and which contains a silica, quartz, talc, silicate, aluminum oxide, aluminum trihydrate (ATH), titanium oxide, dolomite, metal nitride, metal carbide or a combination thereof, wherein said hardenable polymer component contains a monomeric or oligomeric starting material that is a hardenable epoxy resin composition, hardenable polyamide, polybutylene terephthalate, polyurethane, polydicyclopentadiene or a combination thereof, wherein said nano-scale sized filler material contains a silica, zinc oxide, alumina, aluminum trihydrate (ATH), layered silicate, titanium dioxide, metal nitride, metal carbide or a combination thereof, wherein said nano-scale sized filler material is a pretreated nano-scale material, having been produced by a sol-gel process, wherein said nano-scale sized filler material has an average particle size in a range of 2 nm-300 nm.

According to an exemplary aspect, disclosed is a method of producing the hardenable electrical insulation composition, wherein the components are mixed together in any sequence.

According to an exemplary aspect, disclosed is a method of insulating an electrical component, the method comprising insulating an electrical component with the hardenable electrical insulation composition.

According to an exemplary aspect, disclosed is an electrical article comprising an electrical insulation system.

In the production of an electrical insulator for high voltage use, a mineral filler material can be used having an average particle size distribution within the range of 1 μm-500 μm, for example, within the range of 5 μm-100 μm.

In an exemplary aspect, nano-scale sized filler materials, such as nano-scale sized silica, for example, a filler material having an average particle size distribution within the nano-scale, for example, produced by a sol-gel process, can be added to the curable electrical insulation composition or to a single component thereof. A simple mixing method can be used. An excellent dispersion of the nano-particles within the curable electrical insulation composition can be provided. This can be true for nano-scale sized filler materials when produced by a sol-gel process, wherein said nano-scale sized filler material is, for example, selected from the group consisting of silica, zinc oxide, alumina, aluminum trihydrate (ATH), layered silicates, titanium dioxide, metal nitrides and metal carbides.

The addition of such nano-scale sized filler materials can significantly improve the electrical properties of the insulator system, for example, its electrical breakdown strength. For example, a curable electrical epoxy resin composition containing about five parts by weight of nano-scale sized filler material produced by a sol-gel process such as nano-scale sized silica, and about 55 parts by weight of a micro-scale sized filler material having an average particle size distribution within the micro-scale such as micro-scale sized silica, can yield a cured electrical isolator composition with an improved dielectric breakdown strength by up to 50% compared to the cured electrical isolator composition containing 60 parts by weight of micro-scale sized filler only, such as micro-scale sized powdered silica.

This unique simultaneous increase of different properties at low nanofiller content can be highly beneficial for the development of more robust insulation systems. This effect can be due to the good dispersion of the nanofiller as produced by a sol-gel process in the cured epoxy resin composition. The solution can present the additional advantage when the nanofiller is added to the hardenable epoxy resin composition or to a component thereof in the form of a masterbatch. The nanofiller masterbatch can be easily mixable with the epoxy resin composition or a component thereof and thereby can reduce or prevent air contamination so that environmental health and safety can be improved.

### DETAILED DESCRIPTION

According to an exemplary aspect, an electrical insulation system with improved electrical breakdown strength is disclosed, said electrical insulation system comprising a hardened polymer component having incorporated therein a filler material and a nano-scale sized filler material, wherein

(a) said hardened polymer component is selected from epoxy resin compositions, polyesters, polyamides, polybutylene terephthalate, polyurethanes and polydicyclopentadiene, for example, a hardened epoxy resin system;
(b) said filler material can be a suitable filler material having an average particle size distribution within the range of 1 μm-500 μm, being present in a quantity within the range of 40%-65% by weight, calculated to the total weight of the insulator system; and
(c) said nano-scale sized filler material is selected from silica, zinc oxide, alumina, aluminum trihydrate (ATH), layered silicates, titanium dioxide, metal nitrides and metal carbides, wherein said nano-scale sized filler material is a pretreated nano-scale material, having been produced by a sol-gel process; wherein said nano-scale sized filler material is present within the electrical insulation system in an amount of about 1%-20% by weight, calculated to the weight of the filler material (b) present in the electrical insulator system.

According to an exemplary aspect, disclosed is a hardenable electrical insulation composition for the production of the hardened electrical insulation system as defined above, said hardenable electrical insulation composition comprising a hardenable polymer component having incorporated therein a filler material and a nano-scale sized filler material, wherein

(d) said hardenable polymer component is a monomeric or oligomeric starting material of the respective component (a) being selected from hardenable epoxy resin compositions, hardenable polyesters, polyamides, polybutylene terephthalate, polyurethanes and polydicyclopentadiene, for example, a hardenable epoxy resin system;
(e) said filler material is a suitable filler material as defined herein above as component (b), having an average particle size distribution within the range of 1 μm-500 μm, and being present in a quantity within the range of 40%-65% by weight, calculated to the total weight of the hardenable insulator system; and
(f) said nano-scale sized filler material is a filler material as defined herein above as component (c), having been produced by a sol-gel process; and wherein said nano-scale sized filler material is present within the hardenable electrical insulation system in an amount of about 1%-20% by weight, calculated to the weight of the filler material present in the hardenable electrical insulator system.

According to an exemplary aspect, disclosed is a mixture containing the filler material having an average particle size distribution within the range of 1 μm-500 μm defined as component (b) herein above, together with the nano-scale sized filler material defined as component (c) herein above, wherein the nano-scale sized silica powder is present in an amount of 1%-20% by weight, calculated to the weight of the filler material present.

According to an exemplary aspect, disclosed is a masterbatch comprising a hardenable polymer component defined as component (d) herein above, and the selected nano-scale sized filler material as the only filler material, as defined as component (c) herein above.

According to an exemplary aspect, disclosed is a method of producing said hardenable electrical insulation composition, which on curing or hardening yields the hardened electrical insulation system with improved electrical breakdown strength.

According to an exemplary aspect, disclosed is an electrical article comprising said electrical insulation system with improved electrical breakdown strength as defined according to the present disclosure.

According to an exemplary aspect, disclosed is a pretreated nano-scale sized filler material having been produced by a sol-gel process, as defined as component (c) herein above, wherein said pretreated nano-scale sized filler material carries on it surface reactive glycidyl groups, for example, in the form of 3-glycidoxypropylsilyl groups.

The polymer component of the curable electrical insulation composition, yielding the hardened electrical insulation system, may be selected from monomeric and/or oligomeric epoxy resin compositions, monomeric and/or oligomeric polyesters, polyamides, polybutylene terephthalate, polyurethanes and polydicyclopentadiene. For example, the polymer component of the hardenable electrical insulation composition can be a hardenable epoxy resin composition, comprising an epoxy resin component, a hardener component and a curing agent. The expressions “hardened” or “cured”, and “hardenable” or “curable”, are equivalent and applicable for the respective polymer used. The expressions “cross-linked” or “polymerized” can also be used where appropriate.

The filler material [component (b)] can have an average particle size within the range of 5 μm-100 μm, for example, within the range of 5 μm-50 μm, for example, within the range of 5 μm-30 μm. For example, at least 70% of the particles, for example, at least 80% of the particles, have a particle size within the range indicated.

The filler material (b) can be selected from silica, quartz, talc, silicates such as mica, kaolin or a layered silicate, aluminum oxide, aluminum trihydrate (ATH), titanium oxide, dolomite [CaMg(CO₃)₂], metal nitrides, such as silicon nitride, boron nitride and aluminium nitride or metal carbides, such as silicon carbide. Mica (glimmer) and kaolin are exemplary aluminium silicates substantially composed of SiO₂ and Al₂O₃.

The filler material (b) may be surface treated with a suitable coupling agent. The coupling agent can be selected from the group comprising silanes and siloxanes and can be a silane, for example 3-glycidoxypropyltrimethoxysilane or 3-glycidoxypropyldimethoxymethylsilane.

The filler material (b) can be present within the insulator system in a quantity within the range of 50%-65% by weight, for example, in a quantity of about 55%-60% by weight, calculated to the total weight of the insulator system.

The nano-scale sized filler material used according to the present disclosure can be produced by a sol-gel process and can be selected from the group comprising silica, zinc oxide, alumina, aluminum trihydrate (ATH), layered silicates, titanium dioxide, metal nitrides and metal carbides. Exemplary are nano-scale sized filler materials selected from the group comprising silica, zinc oxide, alumina, aluminum trihydrate (ATH), layered silicates and titanium dioxide. Also exemplary are nano-scale sized filler materials selected from the group comprising silica, zinc oxide, alumina, aluminum trihydrate (ATH) and layered silicates, for example, selected from the group comprising silica, alumina, aluminum trihydrate (ATH) and layered silicates. Exemplary are nano-scale sized filler materials selected from the group comprising silica, alumina and aluminum trihydrate (ATH). An example is nano-scale sized silica.

Nano-scale sized metal nitrides can be selected from silicon nitride, boron nitride and aluminum nitride. Nano-scale sized metal carbide can be silicon carbide.

Any suitable manner of preparing the nano-scale materials can be employed. An exemplary sol-gel process for the production of nano-scale sized silica powder is, for example, described in International Publication No. WO 2009/015724 A1, the content of which is herein incorporated by reference.

An exemplary sol-gel process for the production of nano-scale sized zinc oxide dispersions is, for example, described in U.S. Pat. No. 6,699,316, the content of which is incorporated herein by reference. An exemplary sol-gel process for the production of nano-scale sized alpha-alumina powder is, for example, described in U.S. Pat. No. 7,638,105, the content of which is incorporated herein by reference. An exemplary sol-gel process for the production of nano-scale sized layered silicates is, for example, described in Chem. Materials, 1991, 3(5), pages 772-775, the content of which is incorporated herein by reference. Such processes may be used analogously to produce the nano-scale filler materials in accordance with an exemplary aspect. The nano-scale filler material can include nano-scale silica. The contents of International Publication No. WO 2009/015724 A1 which discloses nano-scale silica, is described in detail. Details of International Publication No. WO 2009/015724 A1, for example, with respect to average particle sizes, surface treatment, filler content of the hardenable electrical insulation composition, and production techniques for making the hardenable electrical insulation composition can apply to other nano-scale filler materials mentioned herein.

For example, International Publication No. WO 2009/015724 A1 describes a sol-gel process for the production of a hydrophobic, monodispersed, silicon dioxide, with an average particle size distribution within the nano-scale. The process incorporates the following steps: (a) providing an aqueous suspension of colloidal silicon dioxide with an average particle size within the range of 1 nm to 500 nm; (b) reacting the colloidal silicon dioxide with an organosilane and/or an organosiloxane in an aprotic cyclic ether thereby silanising the colloidal silicon dioxide; (c) separating the aqueous phase of the reaction mixture from the organic phase; (d) adding a further time to the organic phase an organosilane and/or an organosiloxane in an aprotic cyclic ether and silanising the colloidal silicon dioxide; and (e) separating the aqueous phase of the reaction mixture from the organic phase.

The nano-scale sized silica powder can be obtained as a dry solid monodispersed powder subsequent to step (e) by eliminating the solvent from the suspension obtained in step (e), for example, by distilling off the solvent from the suspension under vacuum at elevated temperature. Such dry solid pretreated nano-scale sized silica powder [defined as component (c)] may be used according to an exemplary aspect and can be added at any stage during the preparation of the curable electrical insulation composition, either to a single component or to an intermediate mixture of the curable electrical insulation composition.

The filler starting material used for preparing the nano-scale sized filler material in the sol-gel process, such as the colloidal silicon dioxide, for example, used for preparing the nano-scale sized silica powder in the sol-gel process, can have an average particle size within the range of 2 nm-300 nm, for example, within the range of 3 nm-200 nm, for example, within the range of 4 nm-150 nm, for example, within the range of 4 nm-80 nm, for example, within the range of 10 nm-40 nm.

Said nano-scale sized filler material as obtained in the sol-gel process, with exemplary features as mentioned herein, can be present within the curable electrical insulation composition and the cured electrical insulation system in an amount of about 5%-15% by weight, for example, in an amount of about 8%-12% by weight, for example, in an amount of about 10% by weight, calculated to the weight of the filler material present in the electrical insulator system.

For example, the nano-scale sized filler material as obtained in the sol-gel process, with exemplary features as mentioned herein, for example, the nano-scale sized silica powder, can be present within the electrical insulation system in an amount of about 3% to 8% by weight, for example, at about 5% by weight, calculated to the total weight of the electrical insulator system.

The organosilane and/or an organosiloxane as used in an aprotic cyclic ether for silanising the colloidal filler material such as the silicon dioxide can be a reactive organosilane and/or organosiloxane, for example, a trialkylhalosilane such as trimethylchlorosilane, or a trialkylalkoxysilane such as trimethylmethoxysilane.

For example, the organosilane in the aprotic cyclic ether, thereby silanising for example the colloidal silicon dioxide, can be 3-glycidoxypropyltrimethoxysilane or 3-glycidoxypropyldimethoxymethylsilane. In this way, a pretreated nano-scale sized silica powder can be obtained which carries surface reactive glycidyl groups, such as the 3-glycidoxypropylsilyl groups.

It is possible to make a homogeneous suspension of the nano-scale sized filler material in the form of a masterbatch by intensively mixing the dry solid nano-scale sized filler material with a part of the curable electrical insulation composition or with a component thereof, or with a part of a component thereof. Such a masterbatch, containing the nano-scale sized filler material, can be used for adding the nano-scale filler material to the curable electrical insulation composition at any stage of its preparation. In an exemplary aspect, the nano-scale filler material can be used in the form of a master-batch, for example, as a masterbatch wherein the nano-scale filler material can be dispersed in diglycidylether-bisphenol A (DGEBA-resin) and/or diglycidylether-bisphenol F (DGEBF-resin).

According to an exemplary aspect, disclosed is a method of producing said masterbatch containing the nano-scale sized filler material, wherein the hardenable polymer component in the form of a monomeric or an oligomeric starting material of the respective component (a) defined as component (d) herein above, and the nano-scale sized filler material defined as component (c) herein above, are thoroughly mixed together in a weight ratio so that the nano-scale sized filler material is present in the masterbatch in an amount of 1%-30% by weight, for example, in an amount of 1%-20% by weight, calculated to the total weight of the masterbatch.

According to an exemplary aspect, disclosed is a method of producing a hardenable electrical insulation composition, said composition comprising a hardenable polymer component in the form of a monomeric or oligomeric starting material of the respective component (a); a filler material as defined herein above as component (b), and the nano-scale sized filler material as defined herein above as component (c), wherein the components of the electrical insulation composition are mixed together in any desired sequence.

According to an exemplary aspect, disclosed is a method of producing a hardenable electrical insulation composition, said composition comprising a hardenable polymer component in the form of a monomeric or oligomeric starting material of the respective component (a); a filler material as defined herein above as component (b), and the nano-scale sized filler material as defined herein above as component (c), wherein the components of the electrical insulation composition are mixed together in any desired sequence, whereby said nano-scale sized filler material defined as component (c) is added in the form of a masterbatch at any stage during the production sequence of the electrical insulation composition.

In an exemplary embodiment, disclosed is an electrical insulation system with improved electrical breakdown strength, said electrical insulation system comprising a hardened polymer component having incorporated therein a nano-scale sized filler material (but not containing a filler material (b)), wherein,

said hardened polymer component is identical with component (a) as defined above; and

said nano-scale sized filler material is identical with component (c) as defined above, wherein said nano-scale sized filler material is present within the electrical insulation system in an amount of about 1%-20% by weight, calculated to the total weight of the electrical insulator system.

According to an exemplary aspect, disclosed is a hardenable electrical insulation composition for producing an electrical insulation system, said hardenable electrical insulation composition comprising a hardenable polymer component having incorporated therein a nano-scale sized filler material (but not containing a filler material (b)), wherein,

said hardenable polymer component is a monomeric or an oligomeric starting material of the respective component (a) as defined above; and

said nano-scale sized filler material is identical with component (c) as defined above, wherein said nano-scale sized filler material is present within the electrical insulation system in an amount of about 1%-20% by weight, calculated to the weight of the filler material (b) present in the electrical insulator system.

According to an exemplary aspect, disclosed is a method of producing a hardenable electrical insulation composition, said hardenable composition comprising a hardenable polymer component in the form of a monomeric or oligomeric starting material of the respective component (a) having incorporated therein a nano-scale sized filler material as defined herein above as component (c) (but not containing a filler material (b)), wherein the components are mixed together in any desired sequence.

In such an electrical insulation system, which does not contain a filler material (b), the nano-scale sized filler material as defined herein as component (c) can be present in an amount of about 3%-10% by weight, for example, in an amount of about 3%-8% by weight, for example, at about 5% by weight, calculated to the total weight of the electrical insulator system.

According to an exemplary aspect, disclosed is an electrical article comprising said electrical insulation system comprising a hardened polymer component defined as component (a) herein above, and the nano-scale sized filler material defined as component (c) herein above [excluding the presence of a filler material of component (b)].

The filler component (b) as well as the filler component (c) can be incorporated into the respective monomeric or oligomeric starting material of component (a) analogously to any suitable manner to be uniformly dispersed therein, for example, as described in literature for other filler materials. The non-hardened composition thus obtained, for example, the non-hardened epoxy resin composition, can, for example, be processed using vacuum casting and/or automated pressure gelation (APG) manufacturing processes. The dispersion can be formed into the desired shape using any suitable method, optionally with the help of a molding tool, and then hardened out, optionally using post-curing, whereby an exemplary electrical insulation system can be obtained.

As optional additives the composition may comprise further components selected from wetting/dispersing agents, plasticizers, antioxidants, light absorbers, and from further additives suitable fur use in electrical applications.

Exemplary epoxy resins which can be used are aromatic and/or cycloaliphatic compounds. Said epoxy resins can include reactive glycidyl compounds containing at least two 1,2-epoxy groups per molecule. For example, a mixture of polyglycidyl compounds can be used such as a mixture of diglycidyl- and triglycidyl compounds.

Exemplary epoxy compounds comprise unsubstituted glycidyl groups and/or glycidyl groups substituted with methyl groups. These glycidyl compounds can have a molecular weight between 200 and 1200, for example, between 200 and 1000 and may be solid or liquid. The epoxy value (equiv./100 g) can be at least three, for example, at least four and, for example, at about five, for example, about 4.9 to 5.1. Exemplary are glycidyl compounds which have glycidyl ether- and/or glycidyl ester groups. Such a compound may also contain both kinds of glycidyl groups, for example, 4-glycidyloxy-benzoic acidglycidyl ester. Examples of glycidyl compounds which have glycidyl ether groups include optionally substituted epoxy resins of formula (IV):

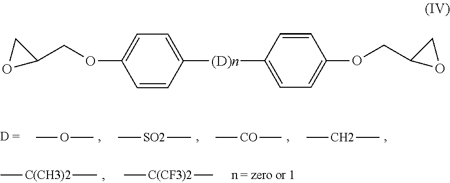

or formula (V):

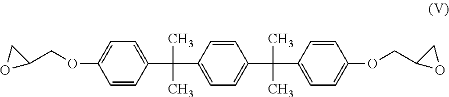 [SMILES: CC(C)(c1ccc(OCC2CO2)cc1)c1ccc(C(C)(C)c2ccc(OCC3CO3)cc2)cc1]

Examples are glycidyl ethers derived from Bisphenol A or Bisphenol F as well as glycidyl ethers derived from Phenol-Novolak-resins or cresol-Novolak-resins.

Cycloaliphatic epoxy resins are for example hexahydro-o-phthalic acid-bis-glycidyl ester, hexahydro-m-phthalic acid-bis-glycidyl ester or hexahydro-p-phthalic acid-bis-glycidyl ester. Also aliphatic epoxy resins, for example 1,4-butane-diol diglycidylether, may be used as a component for an exemplary composition.

Exemplary are aromatic and/or cycloaliphatic epoxy resins which contain at least one, for example, at least two, aminoglycidyl group in the molecule. Exemplary epoxy resins are described in, for example, WO 99/67315. Exemplary compounds are those of formula (VI):

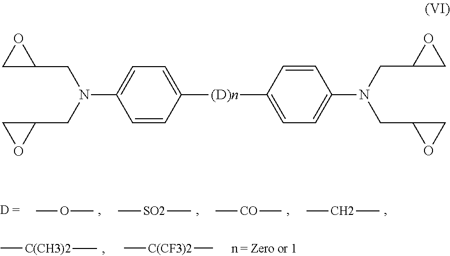

Exemplary aminoglycidyl compounds are N,N-diglycidylaniline, N,N-diglycidyltoluidine, N,N,N′,N′-tetraglycidyl-1,3-diaminobenzene, N,N,N′,N′-tetraglycidyl-1,4-diaminobenzene, N,N,N′,N′-tetraglycidylxylylendiamine, N,N,N′,N′-tetraglycidyl-4,4′-diaminodiphenylmethane, N,N,N′,N′-tetraglycidyl-3,3′-diethyl-4,4′-diaminodiphenylmethane, N,N,N′,N′-tetraglycidyl-3,3′-diaminodiphenylsulfone, N,N′-Dimethyl-N,N′-diglycidyl-4,4′-diaminodiphenylmethane, N,N,N′,N′-tetraglycidyl-alfa,alfa′-bis(4-aminophenyl)-p-diisopropylbenzene and N,N,N′,N′-tetraglycidyl-alfa,alfa′-bis-(3,5-dimethyl-4-aminophenyl)-p-diisopropylbenzene. Exemplary aminoglycidyl compounds are also those of formula (VII):

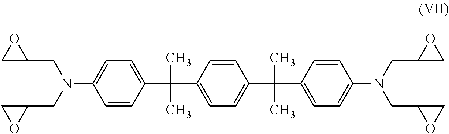 [SMILES: CC(C)(c1ccc(N(CC2CO2)CC2CO2)cc1)c1ccc(C(C)(C)c2ccc(N(CC3CO3)CC3CO3)cc2)cc1]

or of formula (VIII):

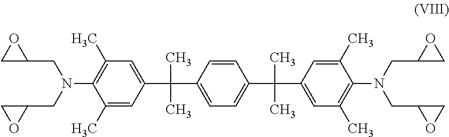 [SMILES: Cc1cc(C(C)(C)c2ccc(C(C)(C)c3cc(C)c(N(CC4CO4)CC4CO4)c(C)c3)cc2)cc(C)c1N(CC1CO1)CC1CO1]

Further aminoglycidyl compounds which can be used are described in e.g. Houben-Weyl, Methoden der Organischen Chemie, Band E20, Makromolekulare Stoffe, Georg Thieme Verlag Stuttgart, 1987, pages 1926-1928.

Hardeners can be used in epoxy resins. Hardeners are for example hydroxyl and/or carboxyl containing polymers such as carboxyl terminated polyester and/or carboxyl containing acrylate- and/or methacrylate polymers and/or carboxylic acid anhydrides. Exemplary hardeners are cyclic anhydrides of aromatic, aliphatic, cycloaliphatic and heterocyclic polycarbonic acids. Exemplary anhydrides of aromatic polycarbonic acids are phthalic acid anhydride and substituted derivates thereof, benzene-1,2,4,5-tetracarbonic acid dianhydride and substituted derivates thereof.

The optional hardener can be used in concentrations within the range of 0.2 to 1.2, equivalents of hardening groups present, for example, one anhydride group per 1 epoxide equivalent. For example, a concentration within the range of 0.2 to 0.4, equivalents of hardening groups can be employed.

As optional additives the composition may comprise at least a curing agent (accelerant) for enhancing the polymerization of the epoxy resin with the hardener, at least one wetting/dispersing agent, plasticizers, antioxidants, light absorbers, as well as further additives used in electrical applications.

Curing agents for enhancing the polymerization of the epoxy resin with the hardener are, for example, tertiary amines, such as benzyldimethylamine or amine-complexes such as complexes of tertiary amines with boron trichloride or boron trifluoride; urea derivatives, such as N-4-chlorophenyl-N′,N′-dimethylurea (Monuron); optionally substituted imidazoles such as imidazole or 2-phenylimidazole. Exemplary are tertiary amines. Other curing catalyst such as transition metal complexes of cobalt (III), copper, manganese, (II), zinc in acetylacetonate may also be used, for example, cobalt acetylacetonate(III). The amount of catalyst used can be in a concentration of about 50-1000 ppm by weight, calculated to the composition to be cured.

Wetting/dispersing agents can be employed, for example, in the form of surface activators; or reactive diluents, for example, epoxy-containing or hydroxyl-containing reactive diluents; thixotropic agents or resinous modifiers. Suitable reactive diluents, for example, include cresylglycidylether, diepoxyethyl-1,2-benzene, bisphenol A, bisphenol F and the diglycidylethers thereof, diepoxydes of glycols and of polyglycols, such as neopentylglycol-diglycidylether or trimethylolpropane-diglycidylether. Exemplary commercially available wetting/dispersing agents are, for example, organic copolymers containing acidic groups, e.g. Byk® W-9010 having an acid value of 129 mg KOH/g). Such wetting/dispersing agents can used in amounts of 0.5% to 1.0% based on the filler weight.

Plasticizers, antioxidants, light absorbers, as well as further additives used in electrical applications can be employed.

The insulating composition made from epoxy resin can be made by mixing all the components, optionally under vacuum, in any desired sequence and curing the mixture by heating. For example, the hardener and the curing agent can be separately added before curing. The curing temperature can be within the range of 50° C. to 280° C., for example, within the range of 100° C. to 200° C. Curing can be made possible also at lower temperatures, whereby at lower temperatures complete curing may last up to several days, depending also on catalyst present and its concentration.

The non-hardened insulating resin composition can be applied by using vacuum casting or automated pressure gelation (APG) manufacturing processes, optionally under the application of vacuum, to remove all moisture and air bubbles from the coil and the insulating composition. The composition may then be cured by any suitable method.

Exemplary uses of the insulation produced include electrical insulations, for example, in the field of impregnating electrical coils and in the production of electrical components such as transformers, bushings, insulators, switches, sensors, converters and cable end seals.

Exemplary uses of the insulation system produced according to an exemplary aspect are also high-voltage insulations for indoor and outdoor use, for example, for outdoor insulators associated with high-voltage lines, as long-rod, composite and cap-type insulators, and also for base insulators in the medium-voltage sector, in the production of insulators associated with outdoor power switches, measuring transducers, lead-throughs, and overvoltage protectors, in switchgear construction, in power switches, dry-type transformers, and electrical machines, as coating materials for transistors and other semiconductor elements and/or to impregnate electrical components. The following examples illustrate exemplary aspects.

### Definition of Raw Materials:

EPR 845: Bisphenol A/F epoxy, Hexion Specialty Chemicals
EPH 845: Modified carboxylic anhydride, Hexion Specialty Chemicals
EPC 845: Modified tertiary amine, Hexion Specialty Chemicals
Microsilica W12: Silica flower d₅₀%=16 μm, Quarzwerke GmbH
Nanopox E470: Masterbatch of silica 5-50 nm nanoparticles (40 wt % SiO₂) dispersed in DGEBA, Nanoresins AG.

### Compositions

The compositions used are given in Table 1:
Reference 1: unfilled epoxy resin composition,
Reference 2: epoxy resin composition filled with Microsilica W12,
Example 1: epoxy resin composition filled with nanosilica, and
Example 2: epoxy resin composition filled with Microsilica W12 and nanosilica (Nanopox E470).

TABLE 1

| | | | | Example 2 |
|---|---|---|---|---|
| | | Example 1 | Reference 2 | epoxy + |
| | | Epoxy + | epoxy + | Nanopox E470 + |
| | Ref. 1 | Nanopox | Microsilica | Microsilica |
| | epoxy | E470 | W12 | W12 |
| EPR 845 | 100 p | 100 p | 100 p | 100 p |
| EPH 845 | 82 p | 96 p | 82 p | 125 p |
| EPC 845 | 1 p | 1 p | 2 p | 3 p |
| Nanopox E470 | | 28 p | | 87 p |
| (with 40% SiO₂) | | | | |
| Microsilica W12 | | | 276 p | 385 p |

### Reference 1 (Sample Preparation)

All the components are separately preheated at a temperature of 90° C. for 2 hours in an oven (Step 1). The components EPH 845 and EPR 845 are mixed together in a mixing apparatus under a vacuum of 0.1 bar and at a temperature of 90° C. for 5 minutes (Step 2). Mixing is then continued during 10 minutes at a temperature of 90° C. under normal pressure, without the application of vacuum (Step 3). Then, EPC 845 is added and mixing is continued under vacuum for further 5 minutes under normal pressure (Step 4). The oven, still being kept at a temperature of 90° C., is then evacuated to a vacuum of 0.1 bar (Step 5) and kept at this vacuum and at this temperature for about 10 minutes. The curable epoxy resin composition is poured into a mold which has been preheated for about 2 hours at 130° C. The mold is then evacuated to a vacuum of 0.1 bar and kept at a temperature of 140° C. for 10 hours to cure the epoxy resin composition.

### Reference 2 (Sample Preparation)

The preparation is made analogous to the sample preparation of Reference 1, with the difference that Microsilica W12 is slowly added in Step 3 and the mixture is mixed for further 10 minutes after the addition has been completed.

### Example 1

### Sample Preparation

The preparation is made analogous to the sample preparation of Reference 1, with the difference that Nanopox E470 is added in Step 2 together with the other components EPH 845 and EPR 845 and all the components are mixed together in a mixing apparatus under a vacuum of 0.1 bar and at a temperature of 90° C. for five minutes.

### Example 2

### Sample Preparation

The preparation is made analogous to the sample preparation of Reference 2, with the difference that Nanopox E470 is added in Step 2 together with the other components EPH 845 and EPR 845 and the mixture is mixed for further 10 minutes after the addition has been completed.

TABLE 2
(Properties of unfilled and microsilica filled epoxy with and without the
addition of Nanopox)

| | | | | | Example 2 |
|---|---|---|---|---|---|
| | | | | Reference 2 | Epoxy + |
| | | | Example 1 | Epoxy + | Nanopox + |
| | | Ref. 1 | Epoxy + | microsilica | microsilica |
| Test | Properties | Epoxy | Nanopox | W12 | W12 |
| DSC | Tg (° C.) | 77 | 79 | 74 | 83 |
| Tensile | E (MPa) | 3260 | 3395 | 9993 | 9571 |
| Strength | std dev. | 128 | 67 | 352 | 268 |
| | σ_{b} (MPa) | 63 | 71 | 84 | 89 |
| | std dev. | 4 | 6 | 3 | 1 |
| | ε_{b} %) | 2.3 | 2.8 | 1.4 | 1.6 |
| | std dev. | 0.3 | 0.8 | 0.2 | 0 |
| Fracture | G_{lc} (kJ/m²) | 304 | 412 | 557 | 528 |
| | std dev. | 28 | 72 | 35 | 55 |

Tg (° C.): glass-transission temperature in ° C.
E (MPa): Young's modulus in MPa
std dev.: Standard deviation
σ_{b} (MPa): Tensile strength in MPa
ε_{b} %): Elongation at break in % (percent)
G_{lc} (kJ/m²): Critical energy release rate in kJ/m²

### Example 3

Analogous results are obtained when the nano-scale sized silica as used in Examples 1 and 2 is replaced by a nano-scale sized zinc oxide dispersion as described in U.S. Pat. No. 6,699,316; a nano-scale sized alpha-alumina powder as described in U.S. Pat. No. 7,638,105; or a nano-scale sized layered silicate as described in Chem. Materials, 1991, 3(5), pages 772-775.

### Discussion

In the case of pure epoxy (Reference 1/Example 1), one can see that the addition of Nanopox has several beneficial and simultaneous effects on the resulting properties: increase of Tg, increase of tensile strength and critical energy release rate. In other cases, increase of Tg can have a negative effect on critical energy release rate. Therefore, these results are surprising.

The amount of EPH 845 in Example 1 (compared to Reference 1) was adjusted because in Example 1 Nanopox is added as a masterbatch constituted of silica nanoparticle dissolved in DGEBA resin. In order to maintain the same stoichiometry (in Reference 1 and Example 1), the amount of anhydride hardener was adjusted.

Comparing the microsilica filled systems (Reference 2/Example 2), one can see that the addition of Nanopox increases significantly the Tg, but also the tensile strength while maintaining good fracture properties. In this case the amount of anhydride has been adjusted to maintain the same stoichiometry and the amount of microsilica was adjusted to maintain the same overall micro/nano silica content.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An electrical insulation system with improved electrical breakdown strength, said electrical insulation system comprising a hardened polymer component (a) having incorporated therein a first filler material (b) and a second nano-scale sized filler material (c),
wherein said hardened polymer component contains an epoxy resin composition, polyester, polyamide, polybutylene terephthalate, polyurethane, polydicyclopentadiene or a combination thereof,
wherein said first filler material (b) contains a silica, quartz, talc, silicate, aluminum oxide, aluminum trihydrate (ATH), titanium oxide, dolomite, metal nitride, metal carbide or a combination thereof,
wherein said second nano-scale sized filler material contains a silica, zinc oxide, alumina, aluminum trihydrate (ATH), layered silicate, titanium dioxide, metal nitride, metal carbide or a combination thereof,
wherein said second nano-scale sized filler material is a pretreated nano-scale material, having been produced by a sol-gel process,
wherein said second nano-scale sized filler material is present in the electrical insulation system in an amount of about 1%-20% by weight,
wherein said second nano-scale sized filler material has an average particle size in a range of 2 nm-300 nm.

2. A hardenable electrical insulation composition for producing a hardened electrical insulation system, said hardenable electrical insulation composition comprising a hardenable polymer component having incorporated therein a first filler material (b) and a second nano-scale sized filler material,
wherein said hardenable polymer component contains a monomeric or oligomeric starting material that is a hardenable epoxy resin composition, hardenable polyamide, polybutylene terephthalate, polyurethane, polydicyclopentadiene or a combination thereof,
wherein said first filler material (b) has an average particle size distribution in a range of 1 μm-500 μm,
wherein said first filler material (b) is present in a quantity in a range of 40%-65% by weight, calculated to the total weight of the hardenable electrical insulation composition,
wherein said second nano-scale sized filler material is produced by a sol-gel process,
wherein said second nano-scale sized filler material is present in the hardenable electrical insulation composition in an amount of about 1%-20% by weight, calculated to the weight of the first filler material (b) present in the hardenable electrical insulation composition.

3. The hardenable electrical insulation composition according to claim 2, wherein said composition comprises at least one component selected from the group consisting of a wetting/dispersing agent, plasticizer, antioxidant, light absorber and a combination thereof.

4. A method of producing the hardenable electrical insulation composition according to claim 2, the method comprising mixing the components of said hardenable electrical insulation composition, optionally under vacuum, in any sequence.

5. The method of producing the hardenable electrical insulation composition according to claim 4, wherein said second nano-scale sized filler material is added in the form of a masterbatch at any stage of the method.

6. The method of producing the hardenable electrical insulation composition according to claim 4, wherein the hardener and the curing agent are separately added before curing.

7. A masterbatch for producing a hardenable electrical insulation composition, said masterbatch comprising:
a hardenable polymer component, and
a nano-scale sized filler material as the only filler material,
wherein said hardenable polymer component contains a monomeric or oligomeric starting material that is a hardenable epoxy resin composition, hardenable polyamide, polybutylene terephthalate, polyurethane, polydicyclopentadiene or a combination thereof,
wherein said nano-scale sized filler material contains a silica, zinc oxide, alumina, aluminum trihydrate (ATH), layered silicate, titanium dioxide, metal nitride, metal carbide or a combination thereof,
wherein said nano-scale sized filler material is a pretreated nano-scale material, having been produced by a sol-gel process,
wherein said nano-scale sized filler material has an average particle size in a range of 2 nm-300 nm.

8. The masterbatch according to claim 7, wherein the nano-scale sized filler material is dispersed in diglycidylether-bisphenol A (DGEBA) and/or diglycidylether-bisphenol F (DGEBF) in a weight ratio so that the nano-scale sized filler material is present in the masterbatch in an amount of 1%-30%, calculated to the total weight of the masterbatch.

9. A mixture for producing a hardenable electrical insulation composition, said mixture comprising:
a first filler material (b), and
a second nano-scale sized filler material,
wherein first said filler material (b) contains a silica, quartz, talc, silicate, aluminum oxide, aluminum trihydrate (ATH), titanium oxide, dolomite, metal nitride, metal carbide or a combination thereof,
wherein said second nano-scale sized filler material contains a silica, zinc oxide, alumina, aluminum trihydrate (ATH), layered silicate, titanium dioxide, metal nitride, metal carbide or a combination thereof,
wherein said second nano-scale sized filler material is a pretreated nano-scale material, having been produced by a sol-gel process,
wherein said second nano-scale sized filler material has an average particle size in a range of 2 nm-300 nm, and
wherein said second nano-scale sized filler material is present in an amount of 1%-20% by weight, calculated to the weight of the first filler material (b).

10. A pretreated nano-scale sized filler material for producing a hardenable electrical insulation composition, the pretreated nano-scale sized filler material comprising a silica, zinc oxide, alumina, aluminum trihydrate (ATH), layered silicate, titanium dioxide, metal nitride, metal carbide or a combination thereof,
wherein said nano-scale sized filler material is a pretreated nano-scale material, having been produced by a sol-gel process,
wherein said nano-scale sized filler material has an average particle size in a range of 2 nm-300 nm,
wherein said pretreated nano-scale sized filler material carries surface reactive glycidyl groups.

11. An electrical insulation system with improved electrical breakdown strength, said electrical insulation system comprising a hardened polymer component having incorporated therein a nano-scale sized filler material,
wherein the hardened polymer component is substantially free of a filler material (b) which has an average particle size distribution in a range of 1 μm-500 μm, and which contains a silica, quartz, talc, silicate, aluminum oxide, aluminum trihydrate (ATH), titanium oxide, dolomite, metal nitride, metal carbide or a combination thereof,
wherein said hardened polymer component contains an epoxy resin composition, polyester, polyamide, polybutylene terephthalate, polyurethane, polydicyclopentadiene or a combination thereof,
wherein said nano-scale sized filler material contains a silica, zinc oxide, alumina, aluminum trihydrate (ATH), layered silicate, titanium dioxide, metal nitride, metal carbide or a combination thereof,
wherein said nano-scale sized filler material is a pretreated nano-scale material, having been produced by a sol-gel process,
wherein said nano-scale sized filler material has an average particle size in a range of 2 nm-300 nm,
wherein said nano-scale sized filler material is present within the electrical insulation system in an amount of about 1%-20%, calculated to the total weight of the electrical insulation system.

12. A hardenable electrical insulation composition for producing an electrical insulation system, wherein said hardenable electrical insulation composition comprises a hardenable polymer component having incorporated therein a nano-scale sized filler material,
wherein the hardened polymer component is substantially free of a filler material (b) which has an average particle size distribution in a range of 1 μm-500 μm, and which contains a silica, quartz, talc, silicate, aluminum oxide, aluminum trihydrate (ATH), titanium oxide, dolomite, metal nitride, metal carbide or a combination thereof,
wherein said hardenable polymer component contains a monomeric or oligomeric starting material that is a hardenable epoxy resin composition, hardenable polyamide, polybutylene terephthalate, polyurethane, polydicyclopentadiene or a combination thereof,
wherein said nano-scale sized filler material contains a silica, zinc oxide, alumina, aluminum trihydrate (ATH), layered silicate, titanium dioxide, metal nitride, metal carbide or a combination thereof,
wherein said nano-scale sized filler material is a pretreated nano-scale material, having been produced by a sol-gel process,
wherein said nano-scale sized filler material has an average particle size in a range of 2 nm-300 nm.

13. A method of producing the hardenable electrical insulation composition according to claim 12, wherein the components are mixed together in any sequence.

14. A method of insulating an electrical component, the method comprising insulating an electrical component with the hardenable electrical insulation composition according to claim 2.

15. An electrical article comprising an electrical insulation system according to claim 1.

16. The electrical insulation system according to claim 1, wherein said hardened polymer component is the hardened epoxy resin composition.

17. The electrical insulation system according to claim 1, wherein said first filler material (b) contains a material selected from the group consisting of mica, kaolin, a layered silicate and a combination thereof.

18. The electrical insulation system according to claim 1, wherein said first filler material (b) has an average particle size distribution within a range of 1 μm-500 μm.

19. The electrical insulation system according to claim 1, wherein said first filler material (b) is present in a quantity within a range of 40%-65% by weight, calculated to the total weight of the insulation system.

20. The electrical insulation system according to claim 1, wherein said first filler material (b) is surface treated with a coupling agent selected from the group consisting of a silane and siloxane, and wherein said first filler material (b) is surface treated with a compound selected from the group consisting of a trialkylhalosilane, trialkylalkoxysilane, 3-glycidoxypropyltrimethoxysilane, 3-glycidoxypropyldimethoxymethylsilane and a combination thereof.

21. The electrical insulation system according to claim 1, wherein said second nano-scale sized filler material contains at least one of:
(i) a metal nitride selected from the group consisting of a silicon nitride, boron nitride, aluminum nitride and a combination thereof;
(ii) a silicon carbide;
(iii) a silica, zinc oxide, alumina, aluminum trihydrate (ATH), layered silicate or a combination thereof; and
(iv) nano-scale sized silica.

22. The electrical insulation system according to claim 1, wherein said second nano-scale sized filler material is present in the electrical insulation system in an amount of about 5%-15% by weight, calculated to the weight of the first filler material (b) present in the electrical insulation system.

23. The electrical insulation system according to claim 1, wherein said second nano-scale sized filler material is present in the electrical insulation system in an amount of 3% to 8% by weight, calculated to the total weight of the electrical insulation system.

24. The electrical insulation system according to claim 1, wherein the second nano-scale sized filler material has an average particle size in a range of 4 nm-150 nm.

25. The hardenable electrical insulation composition according to claim 2, wherein said hardenable polymer component contains the hardenable epoxy resin composition, wherein the hardenable epoxy resin composition contains an epoxy resin component, a hardener component and a curing agent, and wherein the epoxy resin component is an aromatic and/or cycloaliphatic compound containing at least two 1,2-epoxy groups per molecule.

26. The hardenable electrical insulation composition according to claim 25, wherein the aromatic and/or cycloaliphatic compound containing at least two 1,2-epoxy groups per molecule has an epoxy value of at least three.

27. The hardenable electrical insulation composition according to claim 25, wherein the aromatic and/or cycloaliphatic compound containing at least two 1,2-epoxy groups per molecule represents an optionally substituted epoxy resin of formula (IV) or (V):

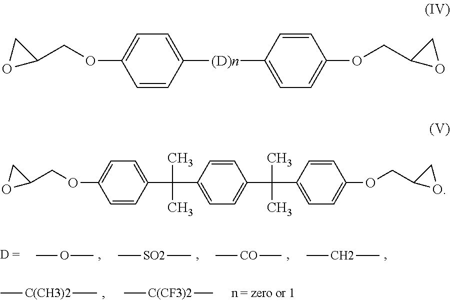

28. The hardenable electrical insulation composition according to claim 25, wherein the epoxy resin component is a glycidyl ether derived from Bisphenol A or Bisphenol F or a glycidyl ether derived from Phenol-Novolak-resins or cresol-Novolak-resins or a cycloaliphatic glycidyl ester compound derived from hexahydro-phthalic acid.

29. The hardenable electrical insulation composition according to claim 2, wherein said second nano-scale sized filler material carries surface reactive glycidyl groups, and wherein the surface reactive glycidyl groups include 3-glycidoxypropylsilyl groups.

30. The masterbatch according to claim 7, wherein the nano-scale sized filler material is dispersed in diglycidylether-bisphenol A (DGEBA) and/or diglycidylether-bisphenol F (DGEBF) in a weight ratio so that the nano-scale sized filler material is present in the masterbatch in an amount of 1%-20% by weight, calculated to the total weight of the masterbatch.

31. The pretreated nano-scale sized filler material according to claim 10, wherein the surface reactive glycidyl groups include 3-glycidoxypropylsilyl groups.

32. The electrical insulation system according to claim 11, wherein said nano-scale sized filler material is present within the electrical insulation system in an amount of about 3%-10%, calculated to the total weight of the electrical insulation system.
